(19) United States
(12) Patent Application Publication
(10) Pub. No.: US 2023/0154339 A1
(43) Pub. Date: May 18, 2023

(54) METHODS OF DETERMINING A RECOMMENDED CRUISE ALTITUDE FOR A FLIGHT PLAN OF AN AIRCRAFT, FLIGHT MANAGEMENT SYSTEMS THAT PERFORM THE METHODS, AND AIRCRAFT THAT INCLUDE THE FLIGHT MANAGEMENT SYSTEMS

(71) Applicant: The Boeing Company, Chicago, IL (US)

(72) Inventors: Daniel Ramiro Rebollo, Madrid (ES); Maxim Constantijn Vos, Madrid (ES); Barend-Jan van Bruchem, Madrid (ES); Pieter van Gils, Madrid (ES); Can Onur, Munich (DE)

(21) Appl. No.: 17/526,829

(22) Filed: Nov. 15, 2021

(51) Int. Cl. G08G 5/00; B64D 43/00

(52) U.S. Cl. CPC G08G 5/0034; B64D 43/00

(57) ABSTRACT

Methods of determining a recommended cruise altitude for a flight plan of an aircraft, flight management systems that perform the methods, and/or aircraft that include the flight management systems are disclosed herein. The methods are computer-implemented methods and include receiving flight plan information regarding the flight plan with a flight management system of the aircraft and electronically determining the recommended cruise altitude for the aircraft utilizing the flight management system and based, at least in part, on the flight plan information and a cruise altitude regulation database that regulates cruise altitude within the flight plan of the aircraft. The flight management system includes a logic unit programmed to perform the methods and a display unit configured to display the recommended cruise altitude for the aircraft to a crew member of the aircraft. The aircraft include a fuselage, a wing, an engine, and the flight management system.

### FIELD

The present disclosure relates generally to methods of determining a recommended cruise altitude for a flight plan of an aircraft, to flight management systems that perform the methods, and/or to aircraft that include the flight management systems.

### BACKGROUND

Flight management systems may be utilized, such as by a crew of an aircraft, to make recommendations on one or more aspects of a flight plan for the aircraft. Conventional flight management systems often make recommendations that are in conflict with applicable regulations and/or that are not permitted by air traffic control. Thus, there exists a need for improved methods of determining a recommended cruise altitude for a flight plan of an aircraft, for flight management systems that perform the methods, and/or for aircraft that include the flight management systems.

### SUMMARY

Methods of determining a recommended cruise altitude for a flight plan of an aircraft, flight management systems that perform the methods, and/or aircraft that include the flight management systems are disclosed herein. The methods are computer-implemented methods and include receiving flight plan information regarding the flight plan with the flight management system of the aircraft and electronically determining the recommended cruise altitude for the aircraft utilizing the flight management system and based, at least in part, on the flight plan information and a cruise altitude regulation database that regulates cruise altitude within the flight plan of the aircraft. The flight management system includes a logic unit programmed to perform the methods and a display unit configured to display the recommended cruise altitude for the aircraft to a crew member of the aircraft. The aircraft include a fuselage, a wing, an engine, and the flight management system.

### BRIEF DESCRIPTION OF THE DRAWINGS

FIG. 1 is schematic illustration of examples of an aircraft that includes a flight management system that performs methods, according to the present disclosure.

FIG. 2 is flowchart depicting examples of computer-implemented methods of determining a recommended cruise altitude for a flight plan of an aircraft, according to the present disclosure.

### DESCRIPTION

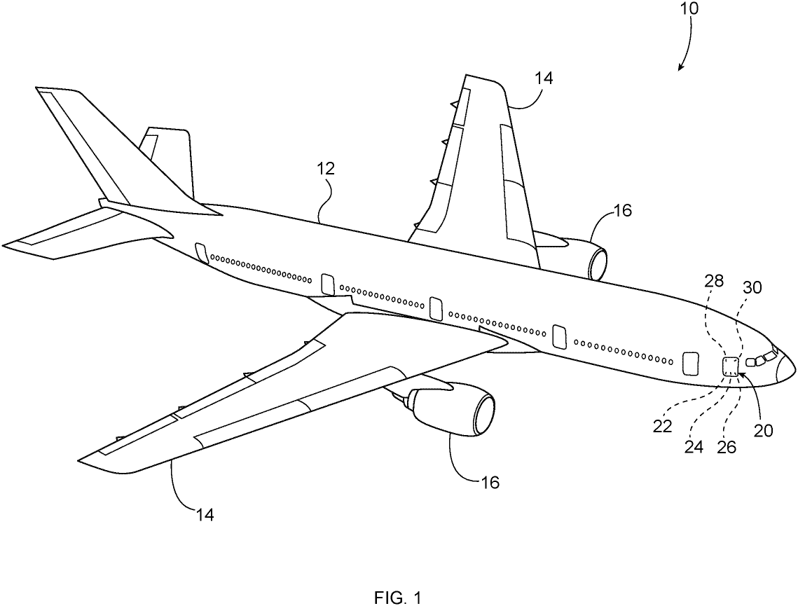

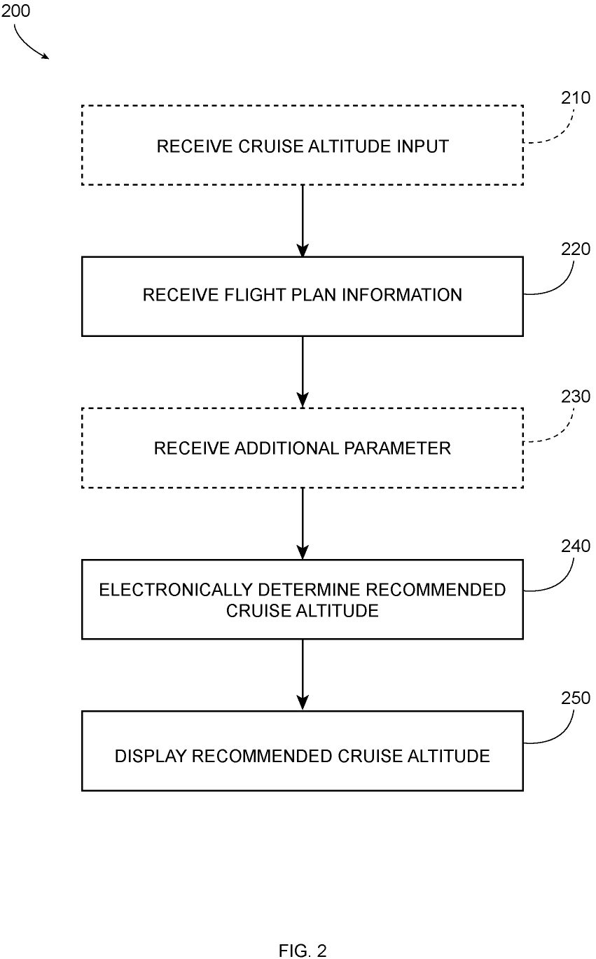

FIGS. 1-2 provide illustrative, non-exclusive examples of aircraft 10, of flight management systems 20, and/or of methods 200, according to the present disclosure. Elements that serve a similar, or at least substantially similar, purpose are labeled with like numbers in each of FIGS. 1-2, and these elements may not be discussed in detail herein with reference to each of FIGS. 1-2. Similarly, all elements may not be labeled in each of FIGS. 1-2, but reference numerals associated therewith may be utilized herein for consistency. Elements, components, and/or features that are discussed herein with reference to one or more of FIGS. 1-2 may be included in and/or utilized with any of FIGS. 1-2 without departing from the scope of the present disclosure.

In general, elements that are likely to be included in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a particular embodiment without departing from the scope of the present disclosure.

FIG. 1 is a schematic illustration of examples of an aircraft 10 that includes a flight management system 20 that performs methods 200, according to the present disclosure. As illustrated in FIG. 1, aircraft 10 includes a fuselage 12, a wing 14, and an engine 16. In the example of FIG. 1, aircraft 10 includes a single fuselage 12, two wings 14 attached to the single fuselage 12, and two engines 16, each attached to a corresponding wing 14. However, this is not required, and it is within the scope of the present disclosure that aircraft 10 may include any suitable number of fuselages 12, wings 14, and/or engines 16, which may be configured and/or operatively attached to one another in any suitable manner. Aircraft 10 may include and/or be any suitable aircraft. As an example, aircraft 10 may include and/or be an aircraft whose flight plan is regulated by a governing body, such as a governing body that may establish, distribute, and/or publish a cruise altitude regulation database, examples of which are disclosed herein. As another example, aircraft 10 may include and/or be a commercial aircraft.

Aircraft 10 also includes flight management system 20. Flight management system 20 includes a logic unit 22 and a display unit 26. Logic unit 22 may be programmed to perform, to direct flight management system 20 to perform, and/or to direct aircraft 10 to perform methods 200, which are discussed in more detail herein. Display unit 26 may be configured to display, to visually display, to indicate, and/or to visually indicate a recommended cruise altitude for aircraft 10, such as to a crew member of the aircraft.

Logic unit 22 may include and/or be any suitable structure, device, and/or devices that may be adapted, configured, designed, constructed, and/or programmed to perform the functions discussed herein. This may include controlling the operation of at least one other component of aircraft 10, such as via and/or utilizing methods 200. As examples, logic unit 22 may include one or more of an electronic logic unit, a dedicated logic unit, a special-purpose logic unit, a personal computer, a special-purpose computer, a display device, a touch screen display, a logic device, a memory device, and/or a memory device having computer-readable storage media 30.

Computer-readable storage media 30, when present, also may be referred to herein as non-transitory computer-readable storage media 30. This non-transitory computer-readable storage media may include, define, house, and/or store computer-executable instructions, programs, and/or code; and these computer-executable instructions may direct aircraft 10 and/or flight management system 20 thereof to perform any suitable portion, or subset, of methods 200. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

Display unit 26 may include any suitable structure that may be adapted, configured, designed, and/or constructed to display the recommended cruise altitude to the crew member. Examples of display unit 26 include a computer display, a heads up display, an electronic display, a liquid crystal display, a light emitting diode display, a plasma display, cathode ray tube display, and/or a printing device.

In some examples, flight management system 20 includes a user input device 24. User input device 24, when present, may be adapted, configured, designed, and/or constructed to receive one or more inputs, such as from the crew member of aircraft 10. As an example, user input device 24 may be configured to receive a cruise altitude input, a suggested cruise altitude input, and/or a desired cruise altitude input from the crew member. As another example, user input device 24 may be configured to receive flight plan information from the crew member. Examples of user input device 24 include a keyboard, a keypad, a touch pad, a mouse, a track ball, and/or a touch screen display.

In some examples, flight management system 20 includes an electronic interface 28, electronic interface 28, when present, may be adapted, configured, designed, and/or constructed to electronically receive one or more electronic inputs. As an example, electronic interface 28 may be configured to electronically receive the suggested cruise altitude input. As another example, electronic interface 28 may be configured to electronically receive the flight plan information. Examples of electronic interface 28 include a wired electronic interface and/or a wireless electronic interface.

During operation of flight management systems 20, during operation of aircraft 10 that include flight management systems 20, and/or during methods 200, flight management system 20 may utilize the flight plan information for aircraft 10 and the cruise altitude regulation database to determine, to establish, and/or to calculate the recommended cruise altitude for aircraft 10. In contrast with conventional flight management systems, which do not utilize the cruise altitude regulation database, flight management systems 20 and/or methods 200, according to the present disclosure, provide recommended cruise altitudes that are consistent with, or permissible by, the cruise altitude regulation database. Stated differently, and regardless of other considerations, such as operating parameters of the aircraft during the flight plan, environmental parameters experienced by the aircraft during the flight plan, and/or crew recommendations regarding cruise altitude, flight management system 20 and/or methods 200 provide recommended cruise altitudes that are consistent with, or permissible by, the cruise altitude regulation database. As such, utilization of flight management systems 20 and/or methods 200, according to the present disclosure, significantly increase a likelihood that an air traffic controller in charge of the aircraft will authorize, permit, and/or approve the recommended cruise altitude.

In addition, and as known to those of ordinary skill in the art, cruise altitude regulation databases, such as those determined by the International Civil Aviation Organization (ICAO) include permissible cruise altitudes that are both location-specific and heading-specific. As discussed in more detail herein, flight management systems 20 and/or methods 200, according to the present disclosure, may utilize location-specific and/or heading-specific information regarding the flight plan of the aircraft 10. This may permit flight management systems 20 and/or methods 200 to accurately generate recommended cruise altitudes, which are consistent with corresponding cruise altitude regulation databases, at any point along the flight path of aircraft 10. This may permit and/or facilitate improved adjustment of cruise altitude, as may be required when a given aircraft 10 changes heading and/or moves from a location governed by one cruise altitude regulation to a location governed by a different cruise altitude regulation.

FIG. 2 is a flowchart depicting examples of computer-implemented methods 200 of determining a recommended cruise altitude for a flight plan of an aircraft, according to the present disclosure. Examples of the aircraft are disclosed herein with reference to aircraft 10. Methods 200 may include receiving a cruise altitude input at 210 and include receiving flight plan information at 220. Methods 200 also may include receiving an additional parameter at 230, electronically determining a recommended cruise altitude at 240, and displaying the recommended cruise altitude at 250.

Receiving the cruise altitude input at 210, when performed, may include receiving any suitable input and may be performed in any suitable manner. As an example, the cruise altitude input may define and/or establish a target and/or desired cruise altitude for the aircraft. In some examples, the receiving at 210 includes receiving the cruise altitude input with, via, utilizing, and/or by a flight management system of the aircraft. Examples of the flight management system are disclosed herein with reference to flight management system 20.

In some examples, the receiving at 210 includes receiving the cruise altitude input from a crew member of the aircraft. In some such examples, the receiving at 210 includes receiving a manual input from the crew member, such as via a user input device of the flight management system. Examples of the user input device are disclosed herein with reference to user input device 24.

In some examples, the receiving at 210 includes electronically receiving the cruise altitude input. In some such examples, the receiving at 210 includes electronically receiving the cruise altitude input with, via, and/or utilizing an electronic interface of the flight management system. Examples of the electronic interface are disclosed herein with reference to electronic interface 28.

When methods 200 include the receiving at 210, the electronically determining at 240 further may be based, at least in part, on the cruise altitude input. As an example, the electronically determining at 240 may include utilizing the cruise altitude input as the recommend cruise altitude when, or in some examples only when, the cruise altitude input indicates a cruise altitude that is permissible by, or within, a cruise altitude regulation database that regulates cruise altitude within the flight plan of the aircraft.

Receiving the flight plan information at 220 may include receiving any suitable flight plan information with, via, and/or utilizing the flight management system of the aircraft. The flight plan information may include information about and/or regarding the flight plan for the aircraft. In some examples, the receiving at 220 includes receiving the flight plan information from the crew member of the aircraft, such as via the user input device of the flight management system. In some examples, the receiving at 220 includes electronically receiving the flight plan information and/or downloading the flight plan information, such as via the electronic interface of the flight management system.

In some examples, the receiving at 220 includes receiving an origin of and/or for the flight plan. In some such examples, the electronically determining at 240 includes electronically determining the recommended cruise altitude based, at least in part, on the origin of the flight plan. In some examples, the receiving at 220 includes receiving a destination of and/or for the flight plan. In some such examples, the electronically determining at 240 includes electronically determining the recommended cruise altitude based, at least in part, on the destination of the flight plan.

In some examples, the receiving at 220 includes receiving a heading for the aircraft during the flight plan. In some such examples, the electronically determining at 240 includes electronically determining the recommended cruise altitude based, at least in part, on the heading. In some such examples, the heading includes and/or is an instantaneous heading for the aircraft at a given time during the flight plan. In some such examples, the heading includes and/or is an overall average heading for the aircraft during an entirety of the flight plan. In some examples, the heading includes, or is, a current average heading for the aircraft during a subset of the flight plan. As an example, the current average heading may include an average heading over a threshold number of kilometers. Examples of the threshold number of kilometers include at least 250 kilometers (km), at least 300 km, at least 350 km, at least 400 km, at least 450 km, at least 500 km, at least 550 km, at least 600 km, at least 700 km, at least 800 km, at most 1000 km, at most 900 km, at most 800 km, at most 700 km, at most 600 km, at most 500 km, and/or at most 400 km.

In some examples, the receiving at 220 includes receiving a current, an existing, a present, and/or an instantaneous position for the aircraft within the flight plan. In some such examples, the current position includes a current latitude and/or a current longitude of the aircraft. In some such examples, the electronically determining at 240 includes electronically determining the recommended cruise altitude based, at least in part, on the current position for the aircraft within the flight plan. As discussed in more detail herein, the cruise altitude regulation database may include location-specific and/or region-specific information regarding permissible cruise altitudes. With this in mind, and in contrast to conventional flight management systems, methods 200 may be utilized to determine recommended cruise altitudes, which are permissible by the cruise altitude regulation database, even if, or when, the aircraft moves from a location within which there is a given set of permissible cruise altitudes to a location within which there is a different set of permissible cruise altitudes.

Receiving the additional parameter at 230 may include receiving at least one additional parameter that may be relevant to the aircraft and/or to the flight plan. When methods 200 include the receiving at 230, the electronically determining at 240 may include electronically determining the recommended cruise altitude for the aircraft based, at least in part, on the at least one additional parameter. In some examples, the at least one additional parameter includes and/or is an operating parameter of the aircraft. Examples of the operating parameter of the aircraft include a gross weight of the aircraft, a cruise speed of the aircraft, and/or an altitude step size for changes in cruise altitude of the aircraft, such as may be desired by the crew and/or permissible by the cruise altitude regulation database. In some examples, the at least one additional parameter includes an environmental parameter along the flight plan of the aircraft. Examples of the environmental parameter include a forecast, or actual, temperature along the flight plan of the aircraft, a forecast, or actual, wind speed along the flight plan of the aircraft, a forecast, or actual, wind direction along the flight plan of the aircraft, a forecast, or actual, weather along the flight plan of the aircraft, and/or a forecast, or actual, pressure at altitude along the flight plan of the aircraft.

Electronically determining the recommended cruise altitude at 240 may include electronically determining the recommended cruise altitude for the aircraft based, at least in part, on the flight plan information and/or on the cruise altitude regulation database. The cruise altitude regulation database may tabulate, or may include a tabulation of, permissible cruise altitudes for the aircraft. These permissible cruise altitudes for the aircraft may be tabulated and/or included as a function of both the heading of the aircraft, such as within the flight plan, and the current position of the aircraft, such as within the flight plan. An example of the cruise altitude regulation database includes the International Civil Aviation Organization (ICAO) database.

In some examples of methods 200, the cruise altitude regulation database may be updated, periodically updated, refreshed, periodically refreshed, modified, and/or periodically modified. Stated differently, methods 200 further may include updating the cruise altitude regulation database, refreshing the cruise altitude regulation database, and/or modifying the cruise altitude regulation database. Such update and/or refresh may be performed on a predetermined update time schedule, may be performed responsive to a change in cruise altitude regulations represented by the cruise altitude regulation database, and/or may be performed responsive to a geographic region within which the aircraft is utilized. In some examples, the cruise altitude regulation database may be stored within memory within the flight management system. In some such examples, the updating, refreshing, and/or modifying may include updating, refreshing, and/or modifying the cruise altitude regulation database within the memory of the flight management system.

In some examples, the electronically determining at 240 includes determining a subset of the cruise altitude regulation database that regulates the cruise altitude within the flight plan. Stated differently, the electronically determining at 240 may include determining a portion, or a subset, of the cruise altitude regulation database that is applicable to the flight plan. As discussed in more detail herein, the flight plan, the origin of the flight plan, the destination of the flight plan, the heading for the flight plan, the current position of the aircraft and/or the current heading of the aircraft each may be utilized to determine the subset of the cruise altitude regulation database that regulates the cruise altitude within the flight plan.

In some such examples, the electronically determining at 240 also includes determining, from the subset of the cruise altitude regulation database, a list of permissible cruise altitudes for the aircraft. Stated differently, the electronically determining at 240 also may include identifying permissible cruise altitudes for the aircraft utilizing and/or from the subset of the cruise altitude regulation database.

In some such examples, the electronically determining at 240 also includes selecting, from the list of permissible cruise altitudes for the aircraft, the recommended cruise altitude for the aircraft. In some examples, this includes selecting, from the list of permissible cruise altitudes for the aircraft, a permissible cruise altitude that has a lowest flight cost as the recommended cruise altitude. The lowest flight cost may be determined by a trajectory predictor for the flight plan and/or may be based upon a time for the flight plan, labor costs (such as crew salaries) for the flight plan, and/or material costs (such as fuel costs) for the flight plan. In some examples, this includes selecting, from the list of permissible cruise altitudes for the aircraft, a permissible cruise altitude that is closest to the cruise altitude input received during the receiving at 210.

As discussed in more detail herein, methods 200, according to the present disclosure, may permit the flight management system to select cruise altitudes, which are permissible by the cruise altitude regulation database, without the need to communicate with air traffic control and/or without the need for air traffic control to verify and/or validate a given cruise altitude as being permissible by the cruise altitude regulation database. With this in mind, methods 200 and/or the electronically determining at 240 may include electronically determining the recommended cruise altitude without communicating with air traffic control, without input form air traffic control, and/or independent from air traffic control.

Displaying the recommended cruise altitude at 250 may include displaying the recommended cruise altitude in any suitable manner and/or for any suitable purpose. As an example, the displaying at 250 may include displaying the recommended cruise altitude on a display unit, such as display unit 26, and/or with the flight management system. As another example, the displaying at 250 may include displaying the recommended cruise altitude to a crew member of the aircraft.

In some examples, the displaying at 250 further includes indicating, to the crew member of the aircraft, that the recommended cruise altitude is a permissible cruise altitude, as determined from the cruise altitude regulation database. Stated differently, the displaying at 250 may include indicating, or visually indicating, that the recommended cruise altitude is compliant with applicable cruise altitude regulations as contained within the cruise altitude regulation database. This may include displaying an additional indicator and/or descriptor that identifies the recommended cruise altitude, which is displayed during the displaying at 250, as being obtained from the cruise altitude regulation database and/or as being compliant with the applicable cruise altitude regulations.

Illustrative, non-exclusive examples of inventive subject matter according to the present disclosure are described in the following enumerated paragraphs:
A1. A computer-implemented method (200) of determining a recommended cruise altitude for a flight plan of an aircraft (10), the method (200) comprising:
   Receiving (220), with a flight management system (20) of the aircraft (10), flight plan information regarding the flight plan; and
   electronically determining (240) the recommended cruise altitude for the aircraft (10) utilizing the flight management system (20) and based, at least in part, on:
   (i) the flight plan information; and
   (ii) a cruise altitude regulation database that regulates cruise altitude within the flight plan of the aircraft (10).
A2. The method (200) of paragraph A1, wherein the method (200) further includes receiving (210) a cruise altitude input, optionally by the flight management system (20) of the aircraft (10), optionally wherein the electronically determining (240) is based, at least in part, on the cruise altitude input, optionally wherein the receiving (210) the cruise altitude input includes receiving the cruise altitude input from a crew member of the aircraft (10), and further optionally wherein the receiving (210) the cruise altitude input includes electronically receiving the cruise altitude input.
A3. The method (200) of any of paragraphs A1-A2, wherein the receiving (220) the flight plan information includes receiving the flight plan information from a/the crew member of the aircraft.
A4. The method (200) of any of paragraphs A1-A3, wherein the receiving (220) the flight plan information includes at least one of:
   (i) electronically receiving the flight plan information; and
   (ii) downloading the flight plan information.
A5. The method (200) of any of paragraphs A1-A4, wherein the receiving (220) the flight plan information includes receiving an origin of the flight plan, and further wherein the electronically determining (240) the recommended cruise altitude is based, at least in part, on the origin of the flight plan.
A6. The method (200) of any of paragraphs A1-A5, wherein the receiving (220) the flight plan information includes receiving a destination of the flight plan, and further wherein the electronically determining (240) the recommended cruise altitude is based, at least in part, on the destination of the flight plan.
A7. The method (200) of any of paragraphs A1-A6, wherein the receiving (220) the flight plan information includes receiving a heading for the aircraft (10) during the flight plan.
A8. The method (200) of paragraph A7, wherein the electronically determining (240) the recommended cruise altitude includes electronically determining the recommended cruise altitude based, at least in part, on the heading.
A9. The method (200) of any of paragraphs A7-A8, wherein the heading includes at least one of:
   (i) an instantaneous heading for the aircraft (10) at a given time during the flight plan;
   (ii) an overall average heading for the aircraft (10) during an entirety of the flight plan; and
   (iii) a current average heading for the aircraft (10) during a subset of the flight plan.
A10. The method of any of paragraphs A1-A9, wherein the receiving (220) the flight plan information includes receiving a current position for the aircraft (10) within the flight plan.
A11. The method (200) of paragraph A10, wherein the electronically determining (240) the recommended cruise altitude includes electronically determining the recommended cruise altitude based, at least in part, on the current position for the aircraft (10).
A12. The method (200) of paragraph A11, wherein the current position includes a current latitude and a current longitude of the aircraft (10).
A13. The method (200) of any of paragraphs A1-A12, wherein the electronically determining (240) the recommended cruise altitude includes:
   (i) determining a subset of the cruise altitude regulation database that regulates the cruise altitude within the flight plan;
   (ii) determining, from the subset of the cruise altitude regulation database, a list of permissible cruise altitudes for the aircraft (10); and
   (iii) selecting, from the list of permissible cruise altitudes for the aircraft (10), the recommended cruise altitude for the aircraft (10).
A14. The method (200) of paragraph A13, wherein the selecting the recommended cruise altitude includes selecting, from the list of permissible cruise altitudes for the aircraft (10), a selected cruise altitude that at least one of:
   (i) has a lowest flight cost as determined by a trajectory predictor for the flight plan; and
   (ii) is closest to a/the cruise altitude input.
A15. The method (200) of any of paragraphs A1-A14, wherein the method further includes displaying (250) the recommended cruise altitude for the aircraft (10) to a/the crew member of the aircraft.
A16. The method (200) of paragraph A15, wherein the displaying (250) includes at least one of:
   (i) displaying on a display unit; and
   (ii) displaying with the flight management system (20).
A16.1 The method (200) of any of paragraphs A15-A16, wherein the displaying (250) includes indicating, to the crew member of the aircraft (10), that the recommended cruise altitude is a permissible cruise altitude as determined from the cruise altitude regulation database.
A17. The method (200) of any of paragraphs A1-A16.1, wherein the cruise altitude regulation database tabulates permissible cruise altitudes for the aircraft (10) as a function of both a/the heading for the aircraft (10) within the flight plan and a/the current position of the aircraft (10) within the flight plan.
A18. The method (200) of any of paragraphs A1-A17, wherein the cruise altitude regulation database includes an International Civil Aviation Organization (ICAO) database.
A18.1 The method (200) of any of paragraphs A1-A18, wherein the method further includes updating the cruise altitude regulation database, optionally wherein the updating includes modifying the cruise altitude regulation database based, at least in part, on at least one of:
   (i) a change in cruise altitude regulations; and
   (ii) a change in a geographic region within which the aircraft (10) is utilized.
A19. The method (200) of any of paragraphs A1-A18.1, wherein the method further includes receiving (230) at least one additional parameter, and further wherein the electronically determining (240) the recommended cruise altitude for the aircraft (10) includes electronically determining the recommended cruise altitude for the aircraft (10) based, at least in part, on the at least one additional parameter.
A20. The method of paragraph A19, wherein the at least one additional parameter includes an operating parameter of the aircraft (10).
A21. The method (200) of paragraph A20, wherein the operating parameter of the aircraft (10) includes at least one of:
   (i) a gross weight of the aircraft (10);
   (ii) a cruise speed of the aircraft (10); and
   (iii) an altitude step size for changes in cruise altitude of the aircraft (10).
A22. The method (200) of any of paragraphs A19-A21, wherein the at least one additional parameter includes an environmental parameter along the flight plan of the aircraft (10).
A23. The method (200) of paragraph A22, wherein the environmental parameter includes at least one of:
   (i) a forecast, or actual, temperature;
   (ii) a forecast, or actual, wind speed;
   (iii) a forecast, or actual, wind direction;
   (iv) a forecast, or actual, weather; and
   (v) a forecast, or actual, pressure at altitude.
B1. Non-transitory computer-readable storage media (30) including computer-readable instructions that, when executed, direct a flight management system (20) to perform the method (200) of any of paragraphs A1-A23.
C1. A flight management system (20) for an aircraft (10), the flight management system (20) comprising:
   a logic unit (22) programmed to perform the method (200) of any of paragraphs A1-A23;
   optionally a user input device (24) configured to receive a/the cruise altitude input, optionally from a/the crew member of the aircraft (10); and
   a/the display unit (26) configured to display a/the recommended cruise altitude for the aircraft (10) to the crew member.
C2. The flight management system (20) of paragraph C1, wherein the user input device (24) further is configured to receive a/the flight plan information from the crew member.
C3. The flight management system (20) of any of paragraphs C1-C2, wherein the flight management system (20) further includes an electronic interface (28) configured to electronically receive the flight plan information.
C4. A flight management system (20) for an aircraft (10), the flight management system (20) comprising:
   a logic unit (22) programmed with instructions which when executed by a processor are configured for:
   receiving (220), with a flight management system (20) of the aircraft (10), flight plan information regarding the flight plan; and
   electronically determining (240) the recommended cruise altitude for the aircraft (10) utilizing the flight management system (20) and based, at least in part, on:
      (i) the flight plan information;
      (ii) a cruise altitude regulation database that regulates cruise altitude within the flight plan of the aircraft (10);
      optionally a user input device (24) configured to receive a/the cruise altitude input, optionally from a/the crew member of the aircraft (10); and
      a/the display unit (26) configured to display a/the recommended cruise altitude for the aircraft (10) to the crew member.
D1. An aircraft (10), comprising:
   a fuselage (12);
   a wing (14);
   an engine (16); and
   the flight management system (20) of any of paragraphs C1-C3.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, A, B, and C together, and optionally any of the above in combination with at least one other entity.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

1. A computer-implemented method of determining a recommended cruise altitude for a flight plan of an aircraft, the method comprising:
receiving, with a flight management system of the aircraft, flight plan information regarding the flight plan; and
electronically determining the recommended cruise altitude for the aircraft utilizing the flight management system and based, at least in part, on:
(i) the flight plan information; and
(ii) a cruise altitude regulation database that regulates cruise altitude within the flight plan of the aircraft.

2. The method of claim 1, wherein the receiving the flight plan information includes at least one of:
(i) electronically receiving the flight plan information;
(ii) downloading the flight plan information; and
(iii) receiving the flight plan information from a crew member of the aircraft.

3. The method of claim 1, wherein the receiving the flight plan information includes receiving an origin of the flight plan, and further wherein the electronically determining the recommended cruise altitude is based, at least in part, on the origin of the flight plan.

4. The method of claim 1, wherein the receiving the flight plan information includes receiving a destination of the flight plan, and further wherein the electronically determining the recommended cruise altitude is based, at least in part, on the destination of the flight plan.

5. The method of claim 1, wherein the receiving the flight plan information includes receiving a heading for the aircraft during the flight plan.

6. The method of claim 5, wherein the electronically determining the recommended cruise altitude includes electronically determining the recommended cruise altitude based, at least in part, on the heading.

7. The method of claim 5, wherein the heading includes at least one of:
(i) an instantaneous heading for the aircraft at a given time during the flight plan;
(ii) an overall average heading for the aircraft during an entirety of the flight plan; and
(iii) a current average heading for the aircraft during a subset of the flight plan.

8. The method of claim 1, wherein the receiving the flight plan information includes receiving a current position for the aircraft within the flight plan.

9. The method of claim 8, wherein the electronically determining the recommended cruise altitude includes electronically determining the recommended cruise altitude based, at least in part, on the current position for the aircraft.

10. The method of claim 1, wherein the electronically determining the recommended cruise altitude includes:
(i) determining a subset of the cruise altitude regulation database that regulates the cruise altitude within the flight plan;
(ii) determining, from the subset of the cruise altitude regulation database, a list of permissible cruise altitudes for the aircraft; and
(iii) selecting, from the list of permissible cruise altitudes for the aircraft, the recommended cruise altitude for the aircraft.

11. The method of claim 10, wherein the selecting the recommended cruise altitude includes selecting, from the list of permissible cruise altitudes for the aircraft, a selected cruise altitude that has a lowest flight cost as determined by a trajectory predictor for the flight plan.

12. The method of claim 1, wherein the method further includes displaying the recommended cruise altitude for the aircraft to a crew member of the aircraft.

13. The method of claim 12, wherein the displaying includes indicating, to the crew member of the aircraft, that the recommended cruise altitude is a permissible cruise altitude as determined from the cruise altitude regulation database.

14. The method of claim 1, wherein the cruise altitude regulation database tabulates permissible cruise altitudes for the aircraft as a function of both a heading for the aircraft within the flight plan and a current position of the aircraft within the flight plan.

15. The method of claim 1, wherein the cruise altitude regulation database includes an International Civil Aviation Organization (ICAO) database.

16. The method of claim 1, wherein the method further includes receiving at least one additional parameter, and further wherein the electronically determining the recommended cruise altitude for the aircraft includes electronically determining the recommended cruise altitude for the aircraft based, at least in part, on the at least one additional parameter.

17. The method of claim 16, wherein the at least one additional parameter includes at least one of:
(i) an operating parameter of the aircraft; and
(ii) an environmental parameter along the flight plan of the aircraft.

18. Non-transitory computer-readable storage media including computer-readable instructions that, when executed, direct a flight management system to perform the method of claim 1.

19. A flight management system for an aircraft, the flight management system comprising:
a logic unit programmed to perform the method of claim 1; and
a display unit configured to display the recommended cruise altitude for the aircraft to a crew member of the aircraft.

20. An aircraft, comprising:
a fuselage;
a wing;
an engine; and
the flight management system of claim 19.
